(19) United States
(12) Patent Application Publication
(10) Pub. No.: US 2012/0310805 A1
(43) Pub. Date: Dec. 6, 2012

(54) INFERRING CREDIT WORTHINESS FROM MOBILE PHONE USAGE

(75) Inventor: Peter Grindrod, Oxon (GB)

(73) Assignee: GMH INTERNATIONAL

(21) Appl. No.: 13/215,047

(22) Filed: Aug. 22, 2011

Related U.S. Application Data
(60) Provisional application No. 61/493,141, filed on Jun. 3, 2011.

(51) Int. Cl. G06Q 40/00

(52) U.S. Cl. 705/35

(57) ABSTRACT

A computer-implemented method for inferring creditworthiness of a mobile phone user. The method can include receiving call level data for a first plurality of mobile phone users and receiving a measure of creditworthiness for a second plurality of mobile phone users. The second plurality of mobile phone users can be a subset of the first plurality of mobile phone users. Attributes can be derived from the call level data. An attribute space can be defined for each mobile phone user based on the attributes. The attribute space can be partitioned into clusters. Each received measure of creditworthiness can be mapped to the cluster corresponding to the mobile phone user. The creditworthiness of each cluster can be characterized as a function of the mapped creditworthiness. The creditworthiness of a given mobile phone user in a given cluster can be characterized as a function of the creditworthiness characterizing the given cluster.

### CROSS REFERENCE TO RELATED APPLICATIONS

This application claims the benefit of U.S. Provisional Patent Application No. 61/493,141, filed Jun. 3, 2011, entitled “Inferring Credit Worthiness from Mobile Phone Usage” the disclosure of which is incorporated herein by reference in its entirety.

### FIELD

The disclosed technology relates to inferring user characteristics from mobile phone usage. The claimed embodiments relate to inferring creditworthiness from mobile phone usage.

### DESCRIPTION OF THE DRAWINGS

Reference will now be made, by way of example, to the accompanying drawings which show example implementations of the technology.

FIG. 1 illustrates methods of the technology.

FIG. 2 illustrates total active population by state by each fortnight.

FIG. 3 illustrates data on the distinctive behavioral states.

FIG. 4 is a graph of credit score versus frequent risk.

FIG. 5 illustrates a Lorenz curve and the associated Gini coefficient obtained in using the ARK Score to identify defaulters.

FIG. 6A-FIG. 6E illustrate a “fingerprint” diagram showing feature distributions for all states. States ordered from left to right by outgoing average daily voice call minutes used.

FIG. 7 illustrates a data processing architecture suitable for storing a computer program product of the present technology and for executing the program code of the computer program product.

### DETAILED DESCRIPTION

Reference now will be made in detail to implementations of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one implementation can be used on another implementation to yield a still further implementation. Thus, it is intended that the present technology cover such modifications and variations that come within the scope of the technology.

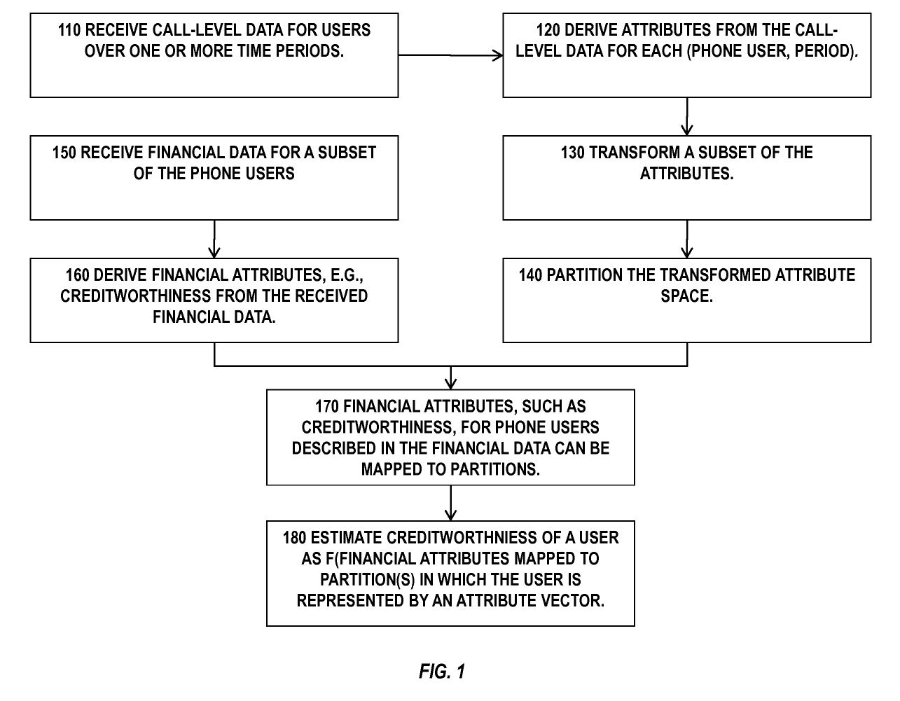

Referring to FIG. 1, the technology can receive call-level data (often termed call data records, CDRs) regarding telecommunication system usage for each of a plurality of telecommunication system users (“phone users”) over one or more time periods 110. The telecommunication system can be one or more conventional cellular network servicing mobile phones and similar devices. Example call-level data include: type of call (voice, SMS, data, WAP), incoming, outgoing, local, regional, national, international, start time of the call, parties to the call, duration of the call, cell location of parties to the call, and cost information of the call (basic rate, discounts, surcharges, etc.). Phone users can be identified in various ways, e.g., mobile phone number, telecommunication system subscriber identity. The time period can be a week, a fortnight, a month, e.g., call-level data can be collected across a plurality of fortnights.

The technology can derive attributes from the call-level data for each (phone user, period) 120 tuple, e.g., during the period from Jan. 1-Jan. 14, the phone user identified by the phone number 123-456-7890 placed 57 local voice calls, 16 national voice call, and 12 international voice calls, 20% of these were between 6 am and 12 noon, 50% between noon and 6 μm, all with an average duration of 3 minutes; the user received (incoming) 105 local voice calls, 12 regional voice calls, 2 international voice calls; with 25% after 6 μm and before midnight, 60% of all of the user's outgoing calls were at weekends; the user made 121 SMS outgoing, and received 133 SMS; the user had only 18 outgoing counterparties and 53 incoming distinct counterparties. Example attributes include: the number of voice calls the phone user makes/receives in the period, by distance classification; the number of SMS messages the phone user sends/receives in the period; the duration (e.g., cumulative, average) of calls involving the phone user in the period; time of day distribution of calls; number of distinct counterparties parties on all calls; location of parties to a call; cost; and frequency of account recharge for that phone user in that period, day part, week part biases. In addition some of the attributes can describe the volatility of usage throughout the period. For example, is the usage pattern for a user uniform across the period?

Some of the attributes can be transformed 130 to reflect user behavior in a more useful way than the untransformed attributes. For example, attributes for a (phone user, period) that are counts can be binned, e.g., number of voice calls, can be binned such that 1 call is mapped to the unit-less value 1, 2-5 calls are mapped to the unit-less value 2, 5-20 calls are mapped to unit-less value 3, etc. The mapping relationship between untransformed and transformed attributes can multinomial, e.g., skews in daytime or week-part can represented by multinomial variables each with a number of values and hence parameters. Transformed attribute types can include integer, continuous, multinomial, binary, and categorical.

The complete set of transformed attributes (including some un-transformed attributes) can be large (e.g., 100 or more). The set of transformed attributes establish an attribute space within which the position of a particular (phone user, period) is represented by a vector of attributes (a single point in the space). The space is thus a mixture of real, binary, and categorical variables.

Using unsupervised discrimination (a.k.a. unsupervised learning) techniques, the technology can partition the transformed attribute vector space so that each (phone user, period) in a partition (e.g., “state”) is similar in some sense to others in that state, e.g., clustering 140. The technology also can determine a transition matrix showing phone users transitioning between states over periods. Determination of states can be by Expectation Maximization (EM) techniques that identify states that fully partition the transformed attribute space (i.e., put each (phone user, period) in a single state); do not contain excessively large or small state populations of (phone user, period)s; and also result in a sparse state transition matrix for phone users across periods.

The partition can be thought of as a “model” characterized by model parameters: it can represent the plethora of distinct (phone-user, period) behaviors and can be used to derive a state-to-state transition matrix that can describe the dynamic behavior. Populations in each state represent a currency with which to describe the distribution of usage-types (behavioral patterns) within and across time periods. Once set up the model can be applied to new datasets of call-level data. Incoming call-level data is first transformed, as described above, and then the model is applied to unambiguously map each (phone user, period) to the modeled partition.

The transformed attribute space, states, and transition between states for both single phone users and groups of phone users can be used for: identifying phone users for specific action, e.g., lead generation, termination, offers to encourage use that is more profitable or discourage less profitable use, reduce churn. Application of such a model for churn/customer management purposes typically can have about 10-20 states, with states named by descriptive terms. Applications of this type of model for risk, e.g., credit scoring as described below, can have 50+ states and result in fine graded description with the states named by their credit score (risk metric).

The technology can receive financial data for a subset of the phone users who also have a financial account (financial services users) 150. The financial data can include data such as: financial user-level information such as a) customer identifier; b) account identifier(s) (e.g., savings, checking, e-wallet, type of credit, investment, 1^{st} mortgage, 2^{nd} mortgage, or other financial products); c) the date of application for a loan; d) the data of approval; e) the date of activations; f) the decisioned credit score; g) the total reported credit transactions and credit repayments history; h) account-level information such as account ID, customer identifier, account balance, next payment date, last payment date, credit limit; and i) transaction-level information such as account identifier, transaction date, transaction amount, transaction type (purchase, payment), and merchant type. Note that “financial services” includes services provided by a broad range of organizations that deal with the management of money. Among these organizations are banks, credit card companies, insurance companies, consumer finance companies, stock brokerages, investment funds and some government sponsored enterprises. Telecommunication service providers are known to offer financial services such as mobile payment. With mobile payment, instead of paying with cash, check or credit cards, a consumer can use a mobile phone to pay for a wide range of services and digital or hard goods. Preferred embodiments include (a) (d) (e) and (g) above.

The technology can derive financial attributes, e.g., creditworthiness from the received financial data 160. Financial attributes for financial services users can be as simple as a decisioned credit score received as part of the financial data. Financial attributes, such as creditworthiness, for phone users described in the financial data can be mapped to states to infer, e.g., estimate, the risk associated with all phone users in the state 170. For example, the distribution of the decisioned credit scores for the financial users who are also phone users in State “T” at the time of their application (and possibly subsequently) can serve as a prediction of the distribution of decisioned credit scores for the whole of phone users in State T 180. Associating at least one financial attribute with a state can allow for: lead generation for financial and telecommunication services of users represented by the group members based on the associated attribute(s); risk prediction and tracking for financial and telecommunication accounts of users, e.g., as described below with regard to Home state; and specification of offer parameters, e.g., credit limits, interest rates, collateral requirements.

For example, the technology can estimate a risk (e.g., a credit score) associated with a phone user by mapping the phone user's states up to and including the last full time period for which the phone user's call-level data is available, in part by mapping the phone onto a “Home” state. The Home state can be e.g., the phone user's most recent state, most prevalent state from the last few time periods. Risk can be estimated for each phone user in each state from financial attributes of phone users in that state who are also financial services users; the risk can be associated with phone users who are not financial services users.

The technology can estimate the risk associated with phone users who are also financial services users in each state, and then represent the Home state based risk by a credit score attributed to those and similar phone users (from that home state) in the future. The score can be a numerical representation of the risk in the phone user's subsequent performance graded by (Home) state. In this sort of model the population can be clustered into at least 50 states, so the score is fine-graded and takes one of 50 possible values (one for each home state) describing the relative risk.

The technology can calculate the significance of the model (the partition) in achieving discrimination (and thus estimating credit scores). This can be done by bootstrap resampling. For example, in a 50-state model for describing behavior/partition loan/credit applicants, the technology can derive a risk measure (e.g., the log of the probability that a phone user from each Home state will default). This in turn can discriminate between higher risk applications and lower risk applications with start measures of the discriminative power of the “home state” categorization. This can be measured in terms of the evidend or evidential value, of the home state classification. The technology can calculate the significance of such a value by providing bootstrap resampled versions of the same “evidential value” under the null hypotheses that “home state” is actually independent of the loan performance. This can state that the result obtained with the actual “home state” partition providing the discrimination is significant at the 99.95% level (meaning that there are less that 5 chances on 10,000, that such evidence could be obtained by chance—under the hypothesis that the “home state” partition (the model) is irrelevant top credit scoring). Thus the model comes with both a performance (discrimination) measure, and a significance test.

In some embodiments the technology can be used to infer creditworthiness of a mobile phone user. For each of a plurality of mobile phone users, receiving call level data for a period of common duration. Deriving attributes from the received call level data, the attributes defining an attribute space within which each mobile phone user is represented by an attribute vector. Partitioning the attribute space into clusters of attribute vectors. Receiving a measure of creditworthiness for each of a subset of the plurality of mobile phone users. For each mobile phone user from the subset, mapping the received measure of creditworthiness to at least one cluster corresponding to the mobile phone user from the subset. Characterizing each cluster as a function of each measure of creditworthiness mapped thereto. Inferring the creditworthiness of a mobile phone user as a function of the creditworthiness characterizing the cluster containing an attribute vector of the mobile phone user.

Example of Technology Deployment

1. Dynamic Behavioral Characteristics and Model Establishment

Data from 2.7M prepay customers' traffic (all calls, all sms, all data, in and out, local, regional, national, international, etc.) over 10 consecutive two-week periods, can be used to partition all such customers' behavior every two-week period (fortnight) into a number of distinct and mutually exclusive behavioral patterns, or clusters, called “states”.

Once established this dynamic behavioral segmentation remains fixed and can be applied to all customers for all fortnights for which full traffic data is available. This can be 2.7M customers in total, for the trial regions.

To build the model a randomly sampled set of 20,000 customers' transacting over a period of 20 consecutive weeks can be employed, e.g., 110.

First, a basic time period can be selected. Accordingly for this example project each customer's data can be divided into consecutive two-weekly time periods (consecutive fortnights). The sample 20,000 customers over 10 fortnights yields 160,110 complete customer-fortnights (the remainder being null where the customer had no traffic whatsoever).

For each two-week time period (fortnight) the technology can summarize each customer's individual behavior by extracting thirty one raw attributes (twenty seven categorical variables and four real-valued metrics), e.g., 120. These can represent different type's usage (voice, sms, and data), incoming and outgoing traffic; local, regional, national and international traffic; skews towards both day parts and week parts; geographical information; and the distribution of total incoming and outgoing usage durations. These parameters are listed in Appendix A.

The raw attributes (fractions, counts and sums) can be transformed, e.g., 130 so as to highlight certain (sensitive) differences, to suppress irrelevancies, and to allow us to adopt certain types of distributions in anticipation of the automated model establishment process discussed below. These transformed attributes in turn can be described by a total of M=112 degrees of freedom (summary parameters). This can define the transformed attribute space. Thus each customer fortnight can be summarized by its location in an M-dimensional transformed attribute space. These parameters are listed in Appendix A. Hence an N=50 state model is fully specified by N−1 mixing parameters (the expected fraction of customer fortnights within each state) and 112×N distribution parameters.

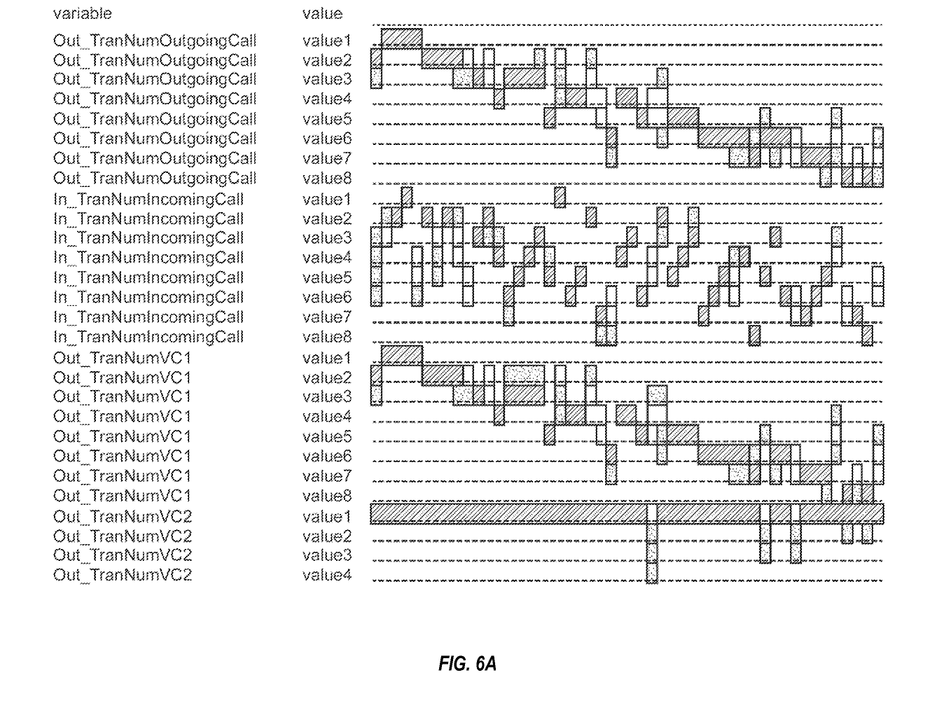

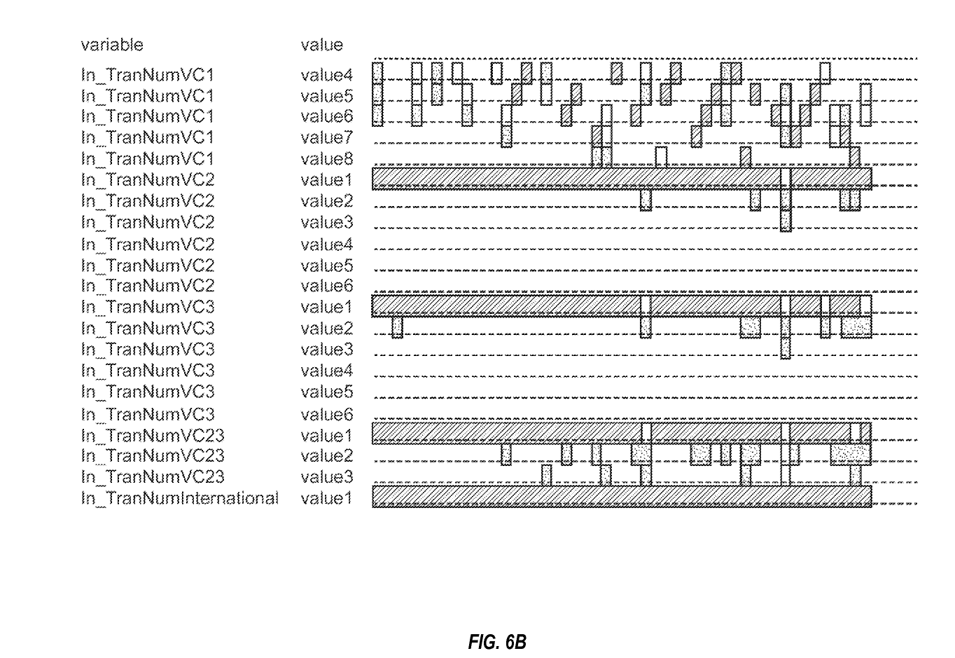

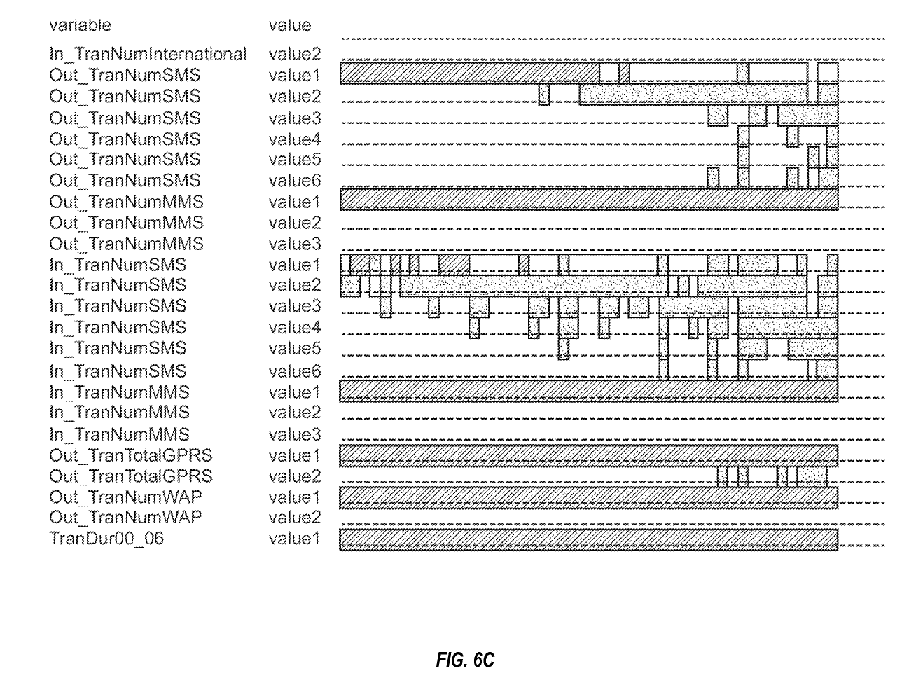

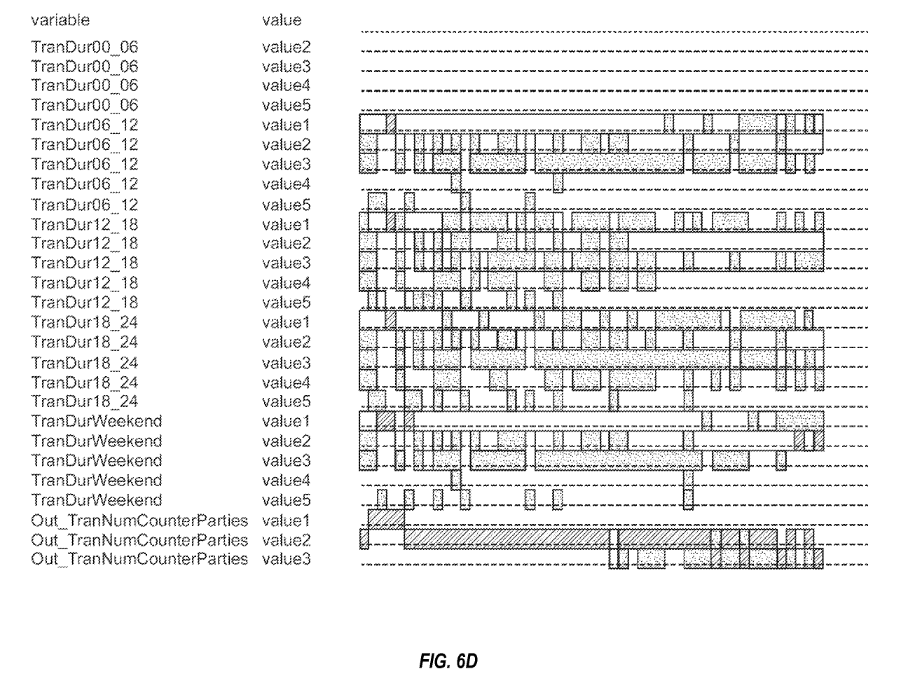

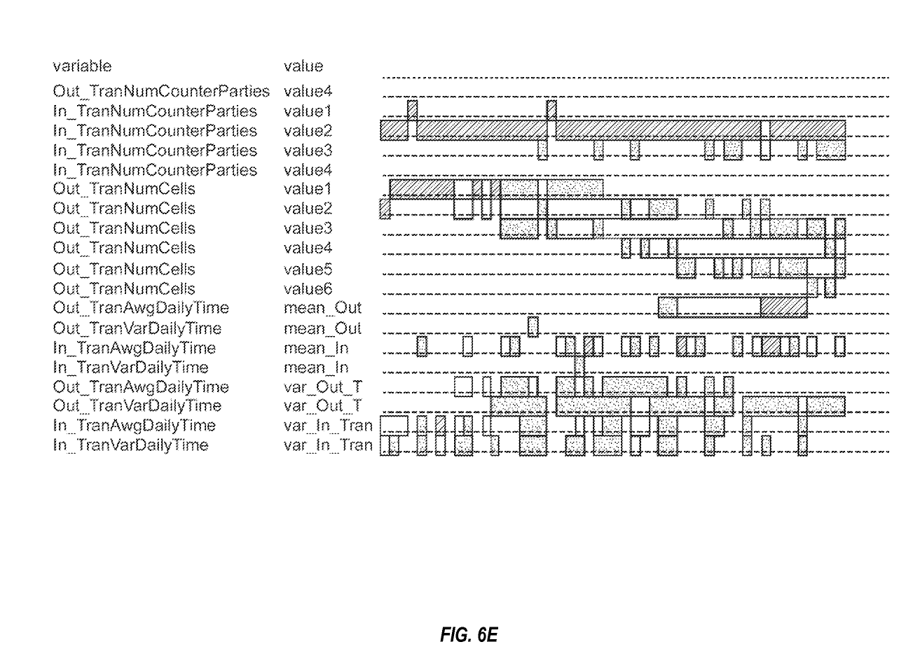

The technology applied to this data employs a version of the EM algorithm producing a description of the whole distribution in terms of a 50-way state partition, e.g., 140. The range of customer-fortnight behavior can thus described by a set of behavioral patterns. Each can represent a typical “fingerprint” of a behavior, characterizing the customer-fortnights within that particular state (partition within in transformed attribute space). See FIG. 6A-FIG. 6B. Each customer fortnight in the whole database can be mapped to a unique behavior state. The model can be subsequently applied to all 2.7M customers' data over those 20 weeks.

A customer can be tracked from time period to time period (fortnight to fortnight): some may remain relatively stationary, and consistent in their behavior; others may move around in a volatile way from state to state, or on a more deterministic trend—a customer journey. The states provide a way of both describing differences in behavior and monitoring individuals' journeys and consistency.

A special state, called the lapsed state, can be included where a customer had no activity at all within a time period.

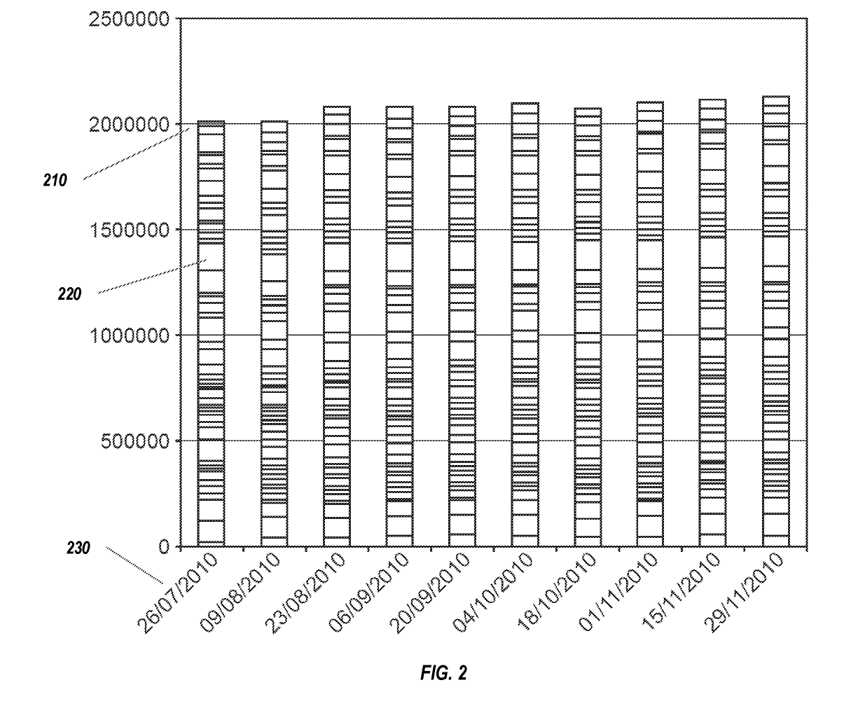

Although the population sizes in each state appear to remain relatively stable (with some long term trends), the picture below hides a good deal of churn and volatility as customer' behavior changes. FIG. 2 illustrates total active population, e.g., 210 by state, e.g., 220 by each fortnight, e.g., 230.

The latter can be highlighted in the state-to-state transition matrix, showing customers' movements from fortnight to successive fortnight, in Appendix B. This example model has been chosen so as to keep this matrix relatively sparse and not to allow the emergence of small trivial states.

What do the states look like? TABLE 1 presents some basic data on the distinctive behavioral states (here they are ordered by ARK score—see next section). Some points to notice are that not all states are the same size; some states have a higher lapse rate than others—that is customers having their current fortnight in certain states are much more likely to “no show” for the successive fortnight; customers in some states are more likely to be stationary, and thus be in the same state in a subsequent fortnight.

TABLE 1
Behavioral State Data.

| | | | | % Moving to | |
|---|---|---|---|---|---|
| Ark | % Total | % Staying | % Moving | double | Average Daily |
| Score | Population | in state | to lapsed | lapsed | Time |
| 800 | 0.34% | 8.08% | 2.80% | 1.28% | 2.29 |
| 799 | 3.64% | 50.08% | 0.39% | 0.33% | 18.60 |
| 798 | 0.94% | 14.17% | 0.80% | 0.49% | 3.75 |
| 797 | 1.36% | 20.19% | 41.59% | 30.55% | 0.00 |
| 796 | 2.11% | 21.18% | 18.62% | 8.77% | 0.05 |
| 795 | 1.09% | 22.81% | 2.07% | 1.02% | 5.04 |
| 794 | 0.85% | 16.99% | 0.32% | 0.20% | 5.76 |
| 793 | 1.37% | 10.55% | 2.47% | 1.06% | 0.97 |
| 792 | 0.62% | 12.69% | 1.62% | 1.17% | 18.25 |
| 791 | 2.78% | 22.61% | 0.88% | 0.68% | 5.60 |
| 790 | 1.41% | 20.68% | 0.20% | 0.15% | 10.96 |
| 789 | 1.21% | 15.03% | 0.31% | 0.20% | 4.24 |
| 788 | 1.74% | 62.47% | 0.20% | 0.16% | 30.01 |
| 787 | 0.85% | 36.46% | 0.15% | 0.12% | 20.30 |
| 786 | 0.64% | 13.69% | 3.31% | 1.47% | 0.69 |
| 735 | 1.08% | 11.66% | 0.76% | 0.40% | 2.13 |
| 683 | 1.76% | 10.67% | 1.98% | 0.94% | 1.36 |
| 673 | 3.72% | 22.69% | 0.52% | 0.40% | 5.49 |
| 668 | 1.11% | 10.10% | 41.06% | 29.55% | 0.07 |
| 668 | 3.16% | 23.19% | 0.31% | 0.23% | 6.34 |
| 653 | 5.02% | 33.20% | 0.38% | 0.31% | 10.29 |
| 652 | 1.15% | 8.92% | 3.45% | 1.55% | 1.16 |
| 637 | 0.95% | 17.34% | 1.32% | 0.88% | 5.45 |
| 634 | 1.18% | 8.54% | 5.97% | 2.44% | 0.60 |
| 629 | 0.71% | 6.99% | 28.27% | 14.75% | 0.02 |
| 624 | 0.56% | 4.57% | 8.50% | 3.83% | 1.07 |
| 620 | 1.23% | 24.83% | 0.31% | 0.23% | 11.53 |
| 617 | 1.14% | 12.28% | 5.25% | 2.74% | 3.98 |
| 616 | 1.39% | 18.48% | 0.54% | 0.37% | 6.95 |
| 608 | 0.90% | 16.45% | 14.45% | 8.32% | 0.36 |
| 607 | 1.17% | 18.50% | 9.19% | 4.01% | 0.11 |
| 603 | 21.51% | 76.82% | 76.82% | 61.24% | 0.00 |
| 600 | 1.33% | 13.38% | 2.00% | 1.07% | 2.46 |
| 596 | 2.70% | 16.53% | 0.67% | 0.45% | 3.49 |
| 594 | 2.77% | 18.87% | 39.45% | 24.20% | 0.01 |
| 592 | 0.37% | 3.23% | 8.20% | 3.75% | 1.16 |
| 584 | 1.61% | 7.21% | 21.64% | 11.63% | 0.23 |
| 581 | 0.85% | 48.07% | 0.20% | 0.14% | 17.99 |
| 575 | 0.93% | 38.97% | 0.15% | 0.13% | 24.37 |
| 573 | 2.75% | 26.37% | 0.59% | 0.51% | 9.28 |
| 564 | 1.17% | 29.55% | 0.34% | 0.26% | 13.28 |
| 564 | 0.88% | 21.18% | 2.04% | 1.14% | 2.53 |
| 549 | 3.23% | 34.28% | 0.25% | 0.20% | 12.86 |
| 544 | 1.83% | 13.03% | 0.80% | 0.42% | 2.14 |
| 536 | 1.37% | 33.58% | 0.16% | 0.11% | 9.59 |
| 525 | 2.08% | 16.48% | 0.32% | 0.21% | 4.91 |
| 507 | 0.61% | 20.51% | 0.69% | 0.34% | 5.00 |
| 494 | 2.04% | 17.54% | 21.03% | 12.51% | 4.31 |
| 484 | 1.71% | 12.63% | 7.52% | 3.44% | 0.63 |

The ARK Score: Applying the Dynamic Behavioral Model to Credit Risk

Data from a large number of active credit loans made through mobile phones, e.g., 150 can be used to determine the risk associated with authorizing such credit to customers from within each behavioral cluster (state). This risk can be reflected in an ARK score allocated to individuals according to their home state (at the time of the credit application). The risk of defaulting after 180 days following first credit billing ranges between 0% up to 40% according to the state of the applicant. This can be reflected in an ARK SCORE giving 800 points to a risk free applicant and reducing by around 60 Points for each doubling of the default risk.

Data from 2,353 loan applicants (making applications during the period August to September 2010) can be analyzed, for which we also had their credit performance status 180 days after their first bill. Each applicant can be mapped to their “home” behavioral state, using their recent transactions immediately prior to the time of their credit application. “Home state” may mean their most recent state (most recent full period for which data is available), or their modal state for a number of periods immediately prior to application, so as to factor out any recent volatility (and hence the uncertainty).

Approval and Denial of Credit

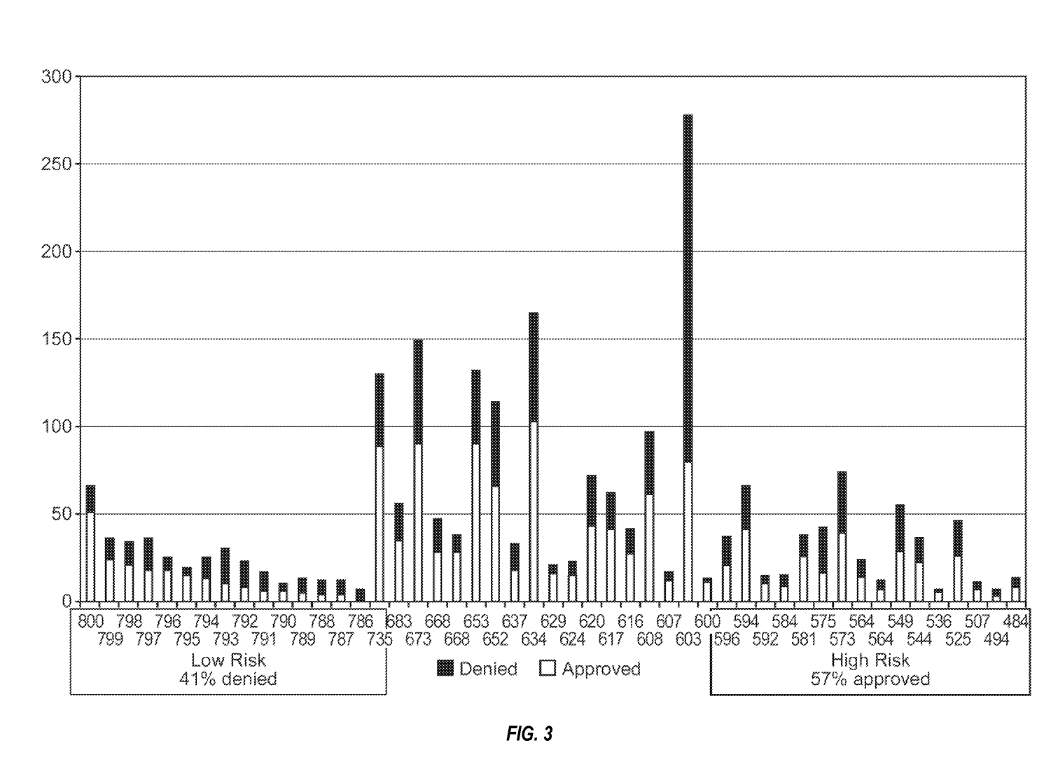

Of the 2,353 applicants, during August and September 2010, 1340 (57%) were approved and 1015 (43%) were denied on the basis of the existing credit approval process (the reasons for denial are given in a table below, set against the ARK Score—and indicator of their actual credit risk (see below). Total of 1340 (57%) approved 1015 (43%) denied. FIG. 3 illustrates customers approved and rejected, banded by their ARK risk scores: TABLE 2 is a matrix of current possible reasons for rejection versus ark scores.

TABLE 2
Possible Reasons for Rejection by ARK Score Band.

| | | | % Denied, | | | % Denied, | % Denied, | | % Denied |
|---|---|---|---|---|---|---|---|---|---|
| | | | the third | | % Denied, | delinquency | HI Pos Num | | registration |
| | | % | unsuccessful | % | defaults | in | Nao belongs | % Denied, | by presenting |
| | % | Denied | attempt to | Denied, | on fixed | tefefonia | to Holder | Other | restrictions |
| Ark Bin | Applicants | (State) | connect | Gave | tefefonia | mobile | Proposal | Cases | SERASA |
| 450 | 0.9 | 45.0 | | | | | | | |
| 500 | 6.6 | 42.6 | | 1.5 | | | | 1.5 | |
| 550 | 14.3 | 42.3 | | 0.7 | 4.2 | 0.7 | 0.7 | 6.3 | 0.7 |
| 600 | 34.4 | 48.5 | 0.8 | 1.0 | 1.3 | 1.0 | | 6.9 | |
| 650 | 22.8 | 37.1 | | 1.5 | 2.5 | | 0.5 | 4.5 | |
| 700 | 5.5 | 31.5 | | | | | | 2.4 | |
| 750 | 15.5 | 44.1 | | 0.6 | | 0.6 | | 5.0 | |
| Totals | 100.0 | 43.0 | 0.3 | 1.0 | 1.6 | 0.6 | 0.2 | 5.4 | 0.1 |

| | | | | | | | | % Denied, |
|---|---|---|---|---|---|---|---|---|
| | | | | | | | | Applicant is |
| | % Denied | | % Denied, | | | | | unaware of |
| | registration | % Denied, | not | | | | | the product |
| | by presenting | for | confirmed | % Denied, by | % Denied by | % Denied by | % Denied by | and not |
| | restrictions | divergent | by | lapse of | Policy | Policy | Policy | requested |
| Ark Bin | SPC | data | data | time | Credit 2 | Credit 3 | Credit 4 | the cards |
| 450 | | | | 11.1 | | | | |
| 500 | | | | 7.6 | | | 3.0 | |
| 550 | | | | 7.7 | | | 1.4 | |
| 600 | 0.5 | | 0.5 | 4.6 | | 0.3 | 1.0 | 0.5 |
| 650 | 1.0 | | | 7.0 | | | 0.5 | |
| 700 | | | | 2.4 | 2.4 | | | 2.4 |
| 750 | 0.6 | 0.6 | | 6.8 | 0.6 | | 1.9 | |
| Totals | 0.5 | 0.1 | 0.2 | 6.0 | 0.2 | 0.1 | 1.2 | 0.3 |

| | | | | % Failed | | | | | |
|---|---|---|---|---|---|---|---|---|---|
| | | | | by the | % Failed | % Failed | | % Failed | |
| | % Denied, | | % Failed | system | by the | by the | % Failed | by the | % Failed |
| | no bidder | | by the | with CPF | system | system | by the | system | by the |
| | has requested | % Denied, | system | Client | based on | over | system | SPC | system |
| | the | Fraud | issuing | restriction | SPC CPF | the age of | Low | score < | holder |
| Ark Bin | product | Suspected | Blacklist | on SPC | None | 80 years | Income | Cut | under 18 |
| 450 | | | | 55.6 | | | 11.1 | 22.2 | |
| 500 | | | 1.5 | 51.5 | | 1.5 | 6.1 | 25.8 | |
| 550 | | 0.7 | 1.4 | 43.7 | | 0.7 | 5.6 | 23.9 | 1.4 |
| 600 | 0.5 | | 1.8 | 49.7 | 0.8 | 0.8 | 3.1 | 24.5 | 0.5 |
| 650 | | | 0.5 | 57.3 | 0.5 | 1.0 | 4.0 | 19.1 | |
| 700 | 2.4 | | | 51.2 | | | 4.9 | 31.7 | |
| 750 | 1.2 | | 1.9 | 50.3 | | 1.2 | 6.8 | 21.1 | 0.6 |
| Totals | 0.5 | 0.1 | 1.4 | 50.7 | 0.4 | 0.9 | 4.6 | 23.2 | 0.5 |

The ARK Risk Score.

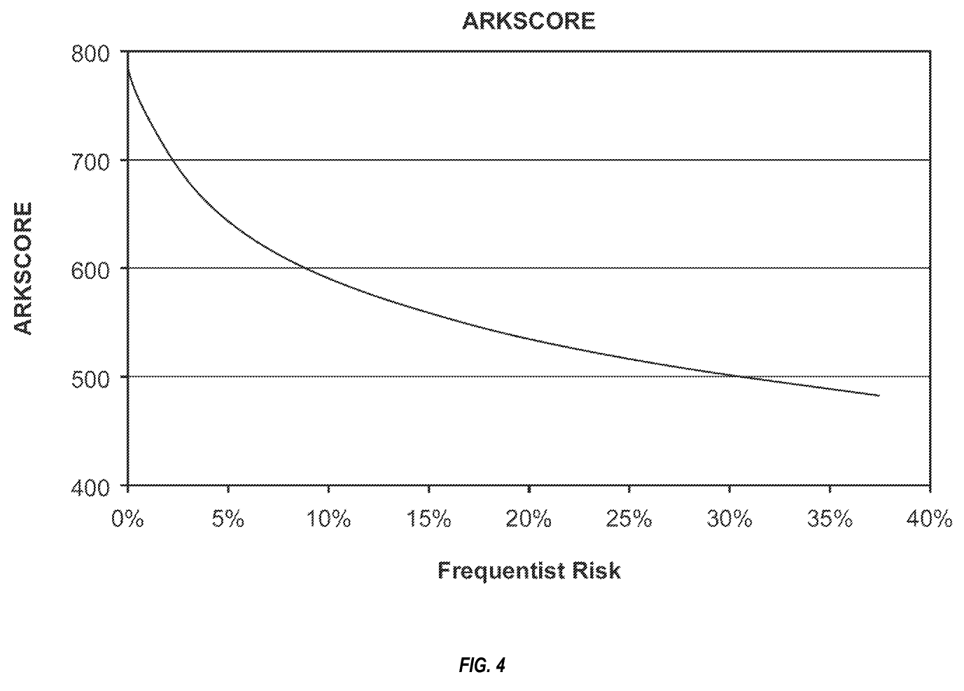

The ARK score can be built using 1340 approved customers of whom 88 were approved, active and defaulting (≧30 days delinquency) customers over 180 day period from credit acceptance, about 7% or 18% of the 485 customers who used the credit line (active customers). The score is monotonically decreasing with the actual (frequency based) risk of a credit default. For every doubling of the risk the ARK score reduces by 60 points. See FIG. 4.

The ARK Score: significance as a predictor for CREDIT RISK.

The risk of lending to customers can be measured in a number of ways. The ARK Score (based on customer's behavioral states) can provide a statistically significant indicator. Indeed the evidence provided by knowing the ARK score can exceed that for other performance measures extracted from the traffic data, and it can be significant at the 99.97% level.

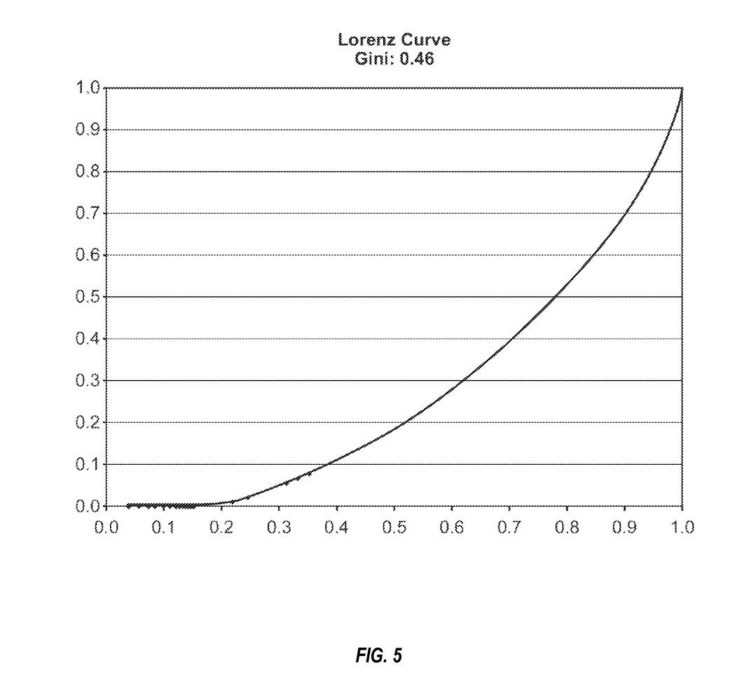

Calculating the evidential value (see E. T. Jaynes, “Probability theory: the logic of science”, Cambridge) for the ARK Score we obtain a result that is significant to 99.97%. This last can be evaluated by a Bootstrapping methodology, obtaining the distribution of all equivalent evidential values achieved under the null hypothesis that the defaults are distributed independently of behavioral state, and hence of the ARK Score. FIG. 5 shows the Lorenz curve and the associated Gini coefficient obtained in using the ARK Score to identify 180 day defaulters: that is those defaulting at or before 180 days (overall that is 6.6% of all approved).

We also evaluated ARK Score as an indicator of earlier defaults. For example if we focus on shorter term defaults (30 days delinquent, 30 days after first bill), we can analyze a much larger cohort—those approved and active during august through November. The overall delinquency for such customers is only 4.7% but the ARK score is even more highly significant indicator due to the larger dataset (the Gini in that case is 0.37 and the evidence provided by the ARK score is significant at the 99.9% level).

The ARK Score: Opportunities to Reduce Risk Whilst Increasing the Market

The ARK Scores can indicate how many previously declined credit applications came from customers with low risk. Though some were declined due to existing fraud markers, others were declined simply due to their lack of four months' history, or other “soft” factors. Credit could have been extended to these customers with high ARK scores (low risk).

Some customers who were accepted in the existing criteria actually have behavior that implies a low ARK score and high risk. In future these could be denied or offered credit at a higher interest rate. As an example, referring to the table showing ARK score bands and pattern of reasons for denial:—

Suppose that we approve all applicants with scores ≧700. Addition=44.1% of 15.5%+31.5% of 5.5%=8.6% of all current applicants. Increases Approvals from 57% to 65.6% of all applicants. Increases of Approvals by 15.1%.

Suppose that we deny all applicants with scores <550. Remove=55% of 0.9%+57.4% of 6.6%=4.3% of all current applicants. Decreases Approvals from 57% to 52.7% of all applicants. Decrease of Approvals by 7.5%.

Do Both: NET Increase of Approvals by 7.6% overall.

The present technology can take the forms of hardware, software or both hardware and software elements. In some implementations, the technology is implemented in software, which includes but is not limited to firmware, resident software, microcode, a Field Programmable Gate Array (FPGA), graphics processing unit (GPU), or Application-Specific Integrated Circuit (ASIC), etc. In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CDROM), compact disk—read/write (CD-R/W) and DVD. Both processors and program code for implementing each as aspect of the technology can be centralized or distributed (or a combination thereof) as known to those skilled in the art.

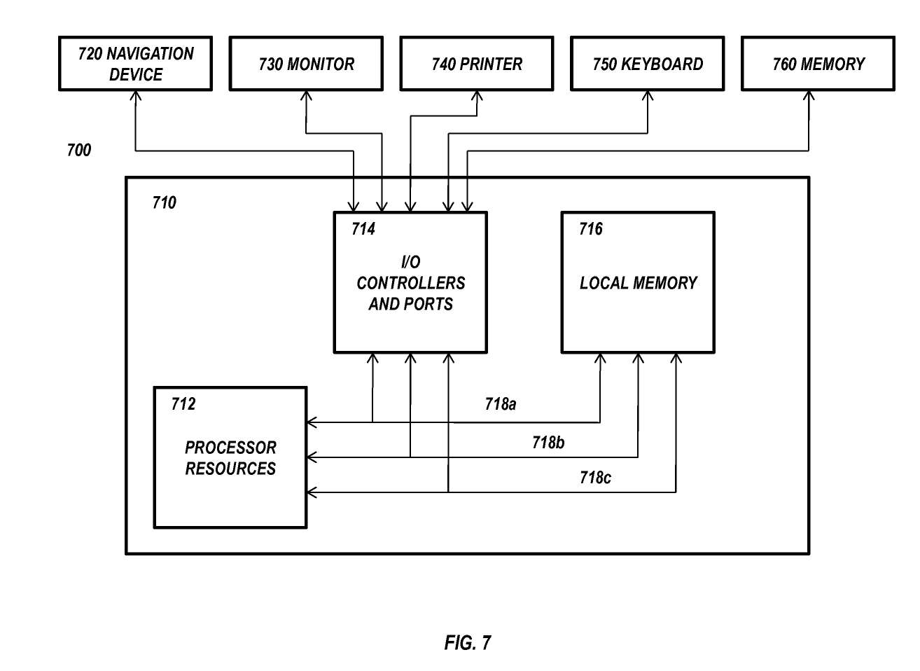

Referring to FIG. 7, a data processing system (e.g., 700) suitable for storing a computer program product of the present technology and for executing the program code of the computer program product can include at least one processor (e.g., processor resources 712) coupled directly or indirectly to memory elements through a system bus (e.g., 718 comprising data bus 718a, address bus 718b, and control bus 718c). The memory elements can include local memory (e.g., 716) employed during actual execution of the program code, bulk storage (e.g., 760), and cache memories (e.g., including cache memory as part of local memory or integrated into processor resources) that provide temporary storage of at least some program code in order to reduce the number of times code must be retrieved from bulk storage during execution. Input/output or I/O devices (including but not limited to keyboards 750, displays 730, pointing devices 720, etc.) can be coupled to the system either directly or through intervening I/O controllers (e.g., 714). Network adapters can also be coupled to the system to enable the data processing system to become coupled to other data processing systems or re-mote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

### APPENDIX A

### Model Transformed Variables

In_TranAvgDailyTime: modelled as a normal: 2 parameters
In_TranNumCounterParties: modelled as a multinomial: 3 parameters
In_TranNumIncomingCall: modelled as a multinomial: 7 parameters
In_TranNumInternational: modelled as a multinomial: 1 parameters
In_TranNumMMS: modelled as a multinomial: 2 parameters
In_TranNumSMS: modelled as a multinomial: 5 parameters
In_TranNumVC1: modelled as a multinomial: 7 parameters
In_TranNumVC2: modelled as a multinomial: 5 parameters
In_TranNumVC23: modelled as a multinomial: 2 parameters
In_TranNumVC3: modelled as a multinomial: 5 parameters
In_TranVarDailyTime: modelled as a normal: 2 parameters
Out_TranAvgDailyTime: modelled as a normal: 2 parameters
Out_TranNumCells: modelled as a multinomial: 5 parameters
Out_TranNumCounterParties: modelled as a multinomial: 3 parameters
Out_TranNumInternational: modelled as a multinomial: 1 parameters
Out_TranNumMMS: modelled as a multinomial: 2 parameters
Out_TranNumNonGeographic: modelled as a multinomial: 3 parameters
Out_TranNumOutgoingCall: modelled as a multinomial: 7 parameters
Out_TranNumSMS: modelled as a multinomial: 5 parameters
Out_TranNumVC1: modelled as a multinomial: 7 parameters
Out_TranNumVC2: modelled as a multinomial: 5 parameters
Out_TranNumVC23: modelled as a multinomial: 2 parameters
Out_TranNumVC3: modelled as a multinomial: 5 parameters
Out_TranNumWAP: modelled as a multinomial: 1 parameters
Out_TranTotaIGPRS: modelled as a multinomial: 1 parameters
Out_TranVarDailyTime: modelled as a normal: 2 parameters
TranDur00_{—}06: modelled as a multinomial: 4 parameters
TranDur06_{—}12: modelled as a multinomial: 4 parameters
TranDur12_{—}18: modelled as a multinomial: 4 parameters
TranDur18_{—}24: modelled as a multinomial: 4 parameters
TranDurWeekend: modelled as a multinomial: 4 parameters
50 state Model
49 mixing parameters
Total number of parameters including group mixing proportions 5649

APPENDIX B
State to State transition matrix, showing customers' movements from fortnight to successive fortnight

| | | Lapsed | | | | | | | | | | | | | | | |
|---|---|---|---|---|---|---|---|---|---|---|---|---|---|---|---|---|---|
| State | | 1 | 2 | 3 | 4 | 5 | 6 | 7 | 8 | 9 | 10 | 11 | 12 | 13 | 14 | 15 | 16 |
| Lapsed | 76.4 | 0.0 | 0.4 | 0.1 | 0.0 | 0.1 | 0.5 | 0.1 | 2.1 | 0.1 | 0.3 | 0.0 | 0.2 | 0.0 | 0.7 | 0.1 | 0.1 |
| 1 | 0.3 | 62.1 | 0.0 | 14.2 | 2.7 | 5.9 | 0.0 | 1.1 | 0.0 | 0.0 | 0.1 | 0.0 | 0.0 | 0.0 | 0.0 | 0.0 | 0.0 |
| 2 | 2.0 | 0.0 | 10.7 | 0.2 | 0.0 | 0.2 | 2.5 | 0.2 | 0.7 | 0.8 | 2.0 | 0.8 | 0.6 | 0.6 | 1.4 | 6.7 | 0.2 |
| 3 | 0.5 | 9.1 | 0.1 | 50.0 | 2.6 | 11.4 | 0.5 | 1.7 | 0.0 | 0.0 | 0.1 | 0.1 | 0.1 | 0.0 | 0.0 | 0.1 | 0.0 |
| 4 | 0.2 | 6.1 | 0.1 | 9.0 | 38.9 | 9.9 | 0.1 | 4.1 | 0.0 | 0.0 | 0.1 | 0.2 | 0.0 | 0.0 | 0.0 | 0.1 | 0.1 |
| 5 | 0.3 | 3.8 | 0.1 | 12.1 | 3.0 | 34.1 | 0.1 | 2.1 | 0.0 | 0.0 | 0.2 | 0.5 | 0.0 | 0.0 | 0.0 | 0.2 | 0.0 |
| 6 | 0.9 | 0.0 | 1.9 | 1.0 | 0.1 | 0.3 | 22.6 | 0.4 | 0.1 | 0.1 | 0.3 | 0.2 | 6.8 | 0.1 | 1.6 | 1.1 | 1.2 |
| 7 | 0.4 | 1.8 | 0.3 | 5.6 | 3.8 | 6.6 | 0.7 | 29.9 | 0.0 | 0.0 | 0.3 | 0.8 | 0.1 | 0.0 | 0.1 | 0.5 | 0.4 |
| 8 | 41.0 | 0.0 | 1.1 | 0.1 | 0.0 | 0.1 | 0.4 | 0.1 | 10.2 | 0.7 | 0.7 | 0.1 | 0.2 | 0.6 | 1.0 | 0.5 | 0.1 |
| 9 | 8.2 | 0.0 | 3.0 | 0.1 | 0.0 | 0.2 | 0.6 | 0.1 | 2.4 | 3.3 | 3.0 | 2.4 | 0.2 | 1.0 | 0.5 | 4.0 | 0.1 |
| 10 | 9.2 | 0.0 | 2.0 | 0.1 | 0.0 | 0.1 | 0.4 | 0.1 | 0.7 | 1.1 | 18.5 | 0.3 | 0.1 | 0.1 | 0.3 | 1.3 | 0.0 |
| 11 | 0.3 | 0.1 | 0.9 | 0.6 | 0.2 | 1.7 | 0.2 | 0.8 | 0.1 | 0.8 | 0.5 | 14.9 | 0.0 | 1.0 | 0.0 | 7.0 | 0.0 |
| 12 | 1.3 | 0.0 | 1.6 | 0.5 | 0.0 | 0.1 | 23.0 | 0.2 | 0.2 | 0.1 | 0.2 | 0.1 | 17.3 | 0.1 | 6.8 | 0.5 | 2.2 |
| 13 | 2.8 | 0.1 | 2.6 | 0.2 | 0.1 | 0.5 | 0.8 | 0.2 | 2.0 | 1.0 | 0.3 | 3.3 | 0.2 | 8.0 | 0.4 | 4.3 | 0.1 |
| 14 | 5.1 | 0.1 | 2.8 | 0.3 | 0.0 | 0.2 | 5.4 | 0.2 | 1.1 | 0.2 | 0.4 | 0.1 | 6.3 | 0.2 | 12.4 | 0.5 | 3.4 |
| 15 | 0.8 | 0.0 | 5.8 | 0.3 | 0.0 | 0.4 | 1.2 | 0.3 | 0.3 | 1.0 | 1.6 | 5.2 | 0.1 | 0.9 | 0.2 | 13.0 | 0.1 |
| 16 | 0.8 | 0.0 | 0.6 | 0.3 | 0.2 | 0.0 | 4.6 | 0.9 | 0.1 | 0.0 | 0.1 | 0.0 | 2.6 | 0.0 | 4.5 | 0.2 | 42.0 |
| 17 | 2.0 | 0.0 | 4.8 | 0.2 | 0.0 | 0.1 | 9.4 | 0.1 | 0.5 | 0.2 | 0.4 | 0.1 | 5.7 | 0.2 | 7.2 | 1.0 | 1.5 |
| 18 | 0.7 | 0.1 | 0.5 | 7.5 | 0.4 | 1.6 | 9.9 | 1.5 | 0.0 | 0.0 | 0.2 | 0.4 | 1.4 | 0.0 | 0.2 | 0.7 | 0.6 |
| 19 | 28.2 | 0.0 | 0.6 | 0.0 | 0.0 | 0.0 | 0.2 | 0.0 | 1.3 | 0.8 | 5.0 | 0.1 | 0.1 | 0.1 | 0.4 | 0.3 | 0.0 |
| 20 | 0.6 | 0.0 | 1.4 | 0.4 | 0.4 | 0.6 | 5.9 | 5.4 | 0.1 | 0.1 | 0.3 | 0.5 | 0.8 | 0.1 | 0.4 | 1.5 | 4.0 |
| 21 | 7.5 | 0.0 | 4.4 | 0.1 | 0.0 | 0.1 | 1.1 | 0.1 | 3.8 | 1.9 | 1.3 | 0.7 | 0.4 | 1.9 | 1.0 | 3.6 | 0.2 |
| 22 | 0.2 | 17.4 | 0.0 | 4.2 | 3.9 | 13.5 | 0.0 | 1.3 | 0.0 | 0.0 | 0.2 | 0.2 | 0.0 | 0.0 | 0.0 | 0.1 | 0.0 |
| 23 | 14.3 | 0.0 | 2.5 | 0.1 | 0.0 | 0.1 | 0.7 | 0.1 | 9.3 | 1.3 | 0.6 | 0.3 | 0.3 | 1.6 | 0.9 | 1.5 | 0.2 |
| 24 | 6.0 | 0.0 | 6.9 | 0.1 | 0.0 | 0.1 | 1.3 | 0.1 | 2.5 | 1.2 | 2.0 | 0.3 | 0.5 | 0.7 | 2.5 | 2.7 | 0.2 |
| 25 | 0.5 | 0.4 | 0.2 | 9.2 | 2.0 | 11.5 | 1.3 | 2.1 | 0.0 | 0.0 | 0.2 | 0.7 | 0.1 | 0.0 | 0.0 | 0.5 | 0.1 |
| 26 | 0.3 | 0.1 | 1.3 | 0.8 | 0.3 | 2.6 | 0.5 | 1.6 | 0.1 | 0.3 | 0.8 | 8.2 | 0.0 | 0.4 | 0.0 | 5.9 | 0.0 |
| 27 | 8.5 | 0.0 | 4.6 | 0.1 | 0.0 | 0.1 | 1.9 | 0.1 | 2.1 | 0.6 | 1.3 | 0.1 | 1.3 | 0.4 | 6.3 | 1.0 | 0.7 |
| 28 | 39.3 | 0.0 | 0.5 | 0.0 | 0.0 | 0.0 | 0.2 | 0.0 | 1.9 | 0.7 | 2.8 | 0.1 | 0.1 | 0.1 | 0.5 | 0.2 | 0.0 |
| 29 | 0.6 | 0.0 | 1.6 | 0.7 | 0.2 | 1.1 | 8.6 | 0.7 | 0.1 | 0.1 | 0.3 | 0.8 | 1.0 | 0.1 | 0.3 | 2.2 | 0.1 |
| 30 | 1.8 | 0.8 | 2.2 | 3.6 | 0.6 | 2.3 | 5.6 | 2.6 | 0.2 | 0.1 | 2.3 | 0.9 | 1.8 | 0.1 | 0.9 | 1.9 | 0.4 |
| 31 | 0.8 | 0.0 | 3.6 | 0.2 | 0.0 | 0.3 | 0.8 | 0.3 | 0.4 | 1.7 | 0.7 | 6.4 | 0.1 | 1.7 | 0.1 | 11.3 | 0.1 |
| 32 | 3.4 | 0.0 | 8.2 | 0.1 | 0.0 | 0.1 | 3.1 | 0.1 | 1.1 | 0.5 | 1.2 | 0.2 | 1.5 | 0.4 | 5.2 | 2.1 | 0.5 |
| 33 | 2.5 | 0.0 | 7.6 | 0.1 | 0.0 | 0.1 | 1.3 | 0.1 | 1.4 | 1.7 | 2.1 | 1.3 | 0.3 | 1.3 | 0.6 | 7.6 | 0.1 |
| 34 | 20.7 | 0.1 | 1.4 | 0.3 | 0.1 | 0.2 | 1.8 | 0.2 | 2.2 | 0.3 | 0.8 | 0.1 | 2.2 | 0.2 | 7.8 | 0.4 | 1.2 |
| 35 | 1.2 | 0.0 | 6.9 | 0.2 | 0.0 | 0.3 | 8.7 | 0.2 | 0.3 | 0.2 | 0.6 | 0.3 | 2.3 | 0.2 | 1.9 | 3.2 | 0.7 |
| 36 | 0.3 | 0.1 | 0.4 | 0.6 | 4.0 | 4.7 | 0.9 | 2.7 | 0.0 | 0.1 | 0.1 | 1.4 | 0.1 | 0.1 | 0.1 | 1.0 | 0.2 |
| 37 | 0.2 | 0.1 | 0.1 | 2.4 | 7.2 | 1.1 | 1.0 | 4.0 | 0.0 | 0.0 | 0.1 | 0.2 | 0.1 | 0.0 | 0.2 | 0.2 | 8.1 |
| 38 | 21.6 | 0.1 | 2.1 | 0.3 | 0.1 | 0.2 | 0.8 | 0.1 | 3.0 | 0.7 | 2.4 | 0.2 | 0.5 | 0.4 | 2.6 | 0.8 | 0.2 |
| 39 | 0.4 | 0.2 | 0.6 | 1.5 | 0.2 | 6.5 | 1.2 | 2.0 | 0.0 | 0.1 | 0.3 | 2.3 | 0.1 | 0.1 | 0.0 | 1.8 | 0.0 |
| 40 | 0.7 | 1.9 | 1.3 | 1.6 | 0.2 | 4.0 | 0.2 | 1.7 | 0.1 | 0.2 | 5.3 | 2.9 | 0.0 | 0.1 | 0.1 | 3.0 | 0.0 |
| 41 | 0.2 | 1.2 | 0.2 | 2.7 | 3.1 | 17.8 | 0.1 | 2.2 | 0.0 | 0.1 | 0.2 | 2.1 | 0.0 | 0.1 | 0.0 | 0.6 | 0.0 |
| 42 | 40.9 | 0.1 | 0.5 | 0.2 | 0.1 | 0.2 | 0.4 | 0.1 | 4.2 | 0.3 | 0.9 | 0.1 | 0.2 | 0.2 | 0.8 | 0.2 | 0.1 |
| 43 | 3.3 | 0.1 | 3.6 | 0.4 | 0.0 | 0.5 | 0.5 | 0.4 | 0.4 | 0.8 | 17.4 | 1.5 | 0.1 | 0.2 | 0.2 | 5.2 | 0.0 |
| 44 | 2.0 | 0.0 | 2.0 | 0.1 | 0.1 | 0.4 | 0.6 | 0.2 | 1.6 | 1.6 | 0.3 | 2.7 | 0.1 | 3.7 | 0.1 | 3.8 | 0.1 |
| 45 | 0.8 | 0.1 | 1.5 | 0.3 | 0.2 | 0.9 | 0.5 | 0.4 | 0.4 | 1.7 | 0.3 | 6.5 | 0.1 | 3.8 | 0.1 | 5.5 | 0.1 |
| 46 | 2.1 | 0.1 | 4.0 | 0.3 | 0.2 | 0.3 | 1.5 | 3.9 | 0.5 | 0.4 | 1.5 | 1.5 | 0.5 | 0.3 | 1.5 | 3.4 | 1.9 |
| 47 | 18.5 | 0.0 | 1.1 | 0.1 | 0.0 | 0.1 | 0.3 | 0.1 | 1.2 | 1.2 | 9.2 | 0.1 | 0.1 | 0.1 | 0.4 | 0.6 | 0.1 |
| 48 | 0.7 | 0.1 | 4.9 | 0.3 | 0.1 | 0.6 | 3.6 | 0.6 | 0.1 | 0.3 | 0.7 | 2.1 | 0.4 | 0.3 | 0.3 | 6.9 | 0.1 |
| 49 | 0.2 | 1.1 | 0.2 | 1.5 | 0.7 | 5.7 | 0.0 | 1.1 | 0.0 | 0.4 | 0.3 | 6.5 | 0.0 | 0.6 | 0.0 | 0.9 | 0.0 |
| 50 | 0.3 | 0.2 | 0.4 | 0.6 | 0.3 | 1.9 | 0.1 | 0.6 | 0.1 | 1.4 | 0.2 | 11.7 | 0.0 | 1.9 | 0.0 | 3.7 | 0.0 |

| | Lapsed | | | | | | | | | | | | | | | | |
|---|---|---|---|---|---|---|---|---|---|---|---|---|---|---|---|---|---|
| State | 17 | 18 | 19 | 20 | 21 | 22 | 23 | 24 | 25 | 26 | 27 | 28 | 29 | 30 | 31 | 32 | 33 |
| Lapsed | 0.5 | 0.3 | 0.7 | 0.1 | 0.6 | 0.0 | 0.6 | 0.4 | 0.3 | 0.1 | 0.3 | 4.1 | 0.5 | 0.2 | 0.1 | 0.4 | 0.2 |
| 1 | 0.0 | 0.1 | 0.0 | 0.0 | 0.0 | 8.3 | 0.0 | 0.0 | 0.8 | 0.1 | 0.0 | 0.0 | 0.1 | 0.3 | 0.0 | 0.0 | 0.0 |
| 2 | 2.9 | 0.7 | 0.5 | 1.1 | 4.9 | 0.0 | 1.5 | 4.9 | 0.7 | 1.8 | 1.4 | 1.4 | 3.2 | 0.6 | 2.8 | 4.8 | 6.8 |
| 3 | 0.0 | 4.3 | 0.0 | 0.1 | 0.0 | 1.3 | 0.0 | 0.0 | 11.4 | 0.4 | 0.0 | 0.0 | 0.6 | 0.6 | 0.0 | 0.0 | 0.0 |
| 4 | 0.0 | 0.6 | 0.0 | 0.5 | 0.0 | 4.3 | 0.0 | 0.0 | 7.7 | 0.6 | 0.0 | 0.0 | 0.4 | 0.3 | 0.0 | 0.0 | 0.0 |
| 5 | 0.0 | 0.8 | 0.0 | 0.2 | 0.0 | 4.6 | 0.0 | 0.0 | 13.9 | 1.6 | 0.0 | 0.0 | 0.8 | 0.4 | 0.1 | 0.0 | 0.0 |
| 6 | 4.0 | 11.8 | 0.1 | 3.3 | 0.6 | 0.0 | 0.2 | 0.6 | 3.8 | 0.6 | 0.4 | 0.2 | 13.9 | 1.3 | 0.4 | 1.3 | 0.8 |
| 7 | 0.1 | 2.9 | 0.0 | 5.4 | 0.1 | 1.1 | 0.0 | 0.1 | 8.9 | 2.8 | 0.1 | 0.1 | 1.9 | 1.4 | 0.2 | 0.1 | 0.1 |
| 8 | 0.6 | 0.2 | 0.9 | 0.1 | 5.2 | 0.0 | 7.1 | 2.2 | 0.2 | 0.2 | 0.9 | 4.6 | 0.3 | 0.1 | 0.3 | 1.0 | 1.5 |
| 9 | 0.5 | 0.3 | 2.0 | 0.3 | 8.4 | 0.1 | 3.4 | 3.2 | 0.5 | 1.7 | 0.7 | 6.3 | 0.9 | 0.2 | 4.4 | 1.1 | 5.6 |
| 10 | 0.3 | 0.2 | 5.1 | 0.2 | 2.0 | 0.0 | 0.5 | 1.8 | 0.3 | 0.5 | 0.6 | 10.6 | 0.4 | 0.5 | 0.4 | 0.9 | 2.0 |
| 11 | 0.0 | 0.6 | 0.1 | 0.5 | 0.9 | 0.2 | 0.2 | 0.3 | 2.7 | 13.1 | 0.0 | 0.2 | 1.7 | 0.4 | 5.5 | 0.1 | 1.4 |
| 12 | 8.2 | 5.8 | 0.1 | 1.5 | 0.7 | 0.0 | 0.3 | 0.9 | 1.2 | 0.2 | 0.8 | 0.4 | 5.7 | 1.3 | 0.2 | 2.1 | 0.6 |
| 13 | 0.5 | 0.5 | 0.2 | 0.4 | 8.8 | 0.2 | 4.6 | 2.2 | 0.9 | 2.3 | 0.4 | 0.9 | 1.3 | 0.2 | 4.9 | 0.9 | 4.5 |
| 14 | 9.0 | 1.2 | 0.3 | 0.7 | 2.0 | 0.0 | 0.8 | 3.3 | 0.6 | 0.2 | 3.5 | 1.6 | 1.6 | 0.6 | 0.2 | 5.8 | 1.1 |
| 15 | 0.5 | 0.9 | 0.2 | 1.1 | 3.6 | 0.1 | 0.8 | 1.7 | 1.4 | 7.0 | 0.2 | 0.6 | 3.7 | 0.6 | 7.3 | 1.0 | 5.8 |
| 16 | 2.7 | 2.9 | 0.1 | 9.3 | 0.4 | 0.0 | 0.2 | 0.4 | 0.5 | 0.1 | 0.5 | 0.2 | 0.9 | 0.4 | 0.1 | 0.9 | 0.3 |
| 17 | 13.5 | 1.4 | 0.2 | 1.5 | 1.7 | 0.0 | 0.6 | 2.6 | 0.7 | 0.3 | 2.4 | 0.8 | 4.2 | 0.8 | 0.3 | 6.5 | 1.5 |
| 18 | 0.4 | 26.3 | 0.0 | 2.1 | 0.1 | 0.0 | 0.0 | 0.1 | 19.5 | 1.0 | 0.1 | 0.1 | 10.6 | 1.2 | 0.3 | 0.2 | 0.2 |
| 19 | 0.3 | 0.1 | 7.0 | 0.1 | 1.6 | 0.0 | 0.4 | 1.1 | 0.1 | 0.1 | 0.5 | 20.7 | 0.2 | 0.1 | 0.1 | 0.5 | 0.8 |
| 20 | 1.1 | 4.6 | 0.1 | 18.6 | 0.4 | 0.0 | 0.1 | 0.4 | 5.0 | 2.3 | 0.2 | 0.2 | 9.4 | 1.0 | 0.5 | 0.7 | 0.5 |
| 21 | 1.1 | 0.4 | 0.9 | 0.4 | 12.5 | 0.0 | 6.8 | 5.1 | 0.3 | 0.8 | 1.2 | 3.6 | 1.0 | 0.2 | 3.4 | 2.1 | 7.2 |
| 22 | 0.0 | 0.1 | 0.0 | 0.0 | 0.0 | 36.4 | 0.0 | 0.0 | 0.8 | 0.6 | 0.0 | 0.0 | 0.1 | 0.2 | 0.0 | 0.0 | 0.0 |
| 23 | 0.9 | 0.2 | 0.4 | 0.2 | 12.1 | 0.0 | 16.5 | 3.8 | 0.2 | 0.3 | 1.0 | 2.2 | 0.5 | 0.1 | 1.5 | 1.7 | 4.5 |
| 24 | 2.2 | 0.4 | 1.0 | 0.5 | 8.4 | 0.0 | 3.5 | 8.5 | 0.3 | 0.5 | 3.0 | 3.5 | 1.0 | 0.3 | 1.4 | 5.3 | 6.6 |
| 25 | 0.1 | 8.3 | 0.0 | 1.1 | 0.1 | 0.2 | 0.0 | 0.1 | 33.1 | 2.0 | 0.0 | 0.1 | 5.5 | 0.7 | 0.2 | 0.1 | 0.1 |
| 26 | 0.1 | 0.9 | 0.1 | 1.2 | 0.5 | 0.3 | 0.1 | 0.3 | 4.2 | 16.6 | 0.0 | 0.2 | 3.9 | 0.8 | 2.6 | 0.2 | 1.0 |
| 27 | 5.2 | 0.4 | 0.9 | 0.5 | 4.6 | 0.0 | 1.9 | 6.7 | 0.3 | 0.3 | 4.6 | 4.1 | 0.9 | 0.4 | 0.4 | 7.1 | 2.7 |
| 28 | 0.3 | 0.1 | 4.9 | 0.1 | 1.8 | 0.0 | 0.6 | 1.0 | 0.1 | 0.1 | 0.6 | 18.9 | 0.1 | 0.1 | 0.1 | 0.5 | 0.6 |
| 29 | 1.1 | 7.6 | 0.1 | 3.3 | 0.4 | 0.0 | 0.1 | 0.3 | 8.8 | 2.9 | 0.1 | 0.1 | 22.7 | 1.1 | 0.8 | 0.6 | 0.7 |
| 30 | 1.6 | 5.1 | 0.3 | 2.1 | 0.6 | 0.3 | 0.2 | 0.7 | 6.6 | 3.0 | 0.4 | 0.7 | 6.6 | 12.8 | 0.6 | 1.1 | 0.8 |
| 31 | 0.2 | 0.7 | 0.1 | 0.8 | 5.4 | 0.0 | 1.4 | 1.3 | 1.1 | 5.1 | 0.2 | 0.4 | 2.4 | 0.4 | 11.6 | 0.5 | 6.5 |
| 32 | 6.9 | 0.6 | 0.6 | 0.9 | 4.1 | 0.0 | 1.5 | 6.3 | 0.5 | 0.5 | 3.5 | 1.9 | 2.1 | 0.5 | 0.7 | 9.0 | 3.9 |
| 33 | 1.0 | 0.5 | 0.6 | 0.6 | 9.8 | 0.0 | 3.5 | 5.3 | 0.5 | 1.6 | 1.0 | 1.8 | 1.7 | 0.4 | 5.3 | 2.6 | 10.5 |
| 34 | 3.6 | 0.6 | 1.2 | 0.4 | 2.1 | 0.0 | 1.0 | 2.5 | 0.5 | 0.2 | 2.4 | 5.9 | 0.8 | 0.3 | 0.2 | 3.0 | 0.8 |
| 35 | 6.5 | 1.7 | 0.2 | 3.0 | 1.7 | 0.0 | 0.5 | 2.1 | 1.3 | 1.2 | 1.0 | 0.5 | 9.1 | 1.0 | 1.0 | 4.3 | 2.5 |
| 36 | 0.1 | 2.2 | 0.0 | 3.7 | 0.1 | 0.2 | 0.0 | 0.1 | 12.1 | 5.7 | 0.0 | 0.1 | 7.9 | 0.7 | 0.4 | 0.1 | 0.2 |
| 37 | 0.2 | 3.4 | 0.0 | 7.5 | 0.1 | 0.1 | 0.0 | 0.1 | 5.5 | 0.5 | 0.1 | 0.1 | 1.0 | 0.2 | 0.1 | 0.1 | 0.1 |
| 38 | 1.5 | 0.4 | 2.6 | 0.3 | 4.2 | 0.0 | 2.1 | 3.9 | 0.5 | 0.3 | 2.2 | 10.1 | 0.6 | 0.3 | 0.4 | 2.6 | 1.8 |
| 39 | 0.1 | 3.0 | 0.0 | 1.9 | 0.2 | 0.2 | 0.0 | 0.1 | 14.4 | 7.6 | 0.0 | 0.1 | 9.7 | 0.8 | 0.7 | 0.1 | 0.3 |
| 40 | 0.1 | 0.5 | 0.3 | 0.3 | 0.4 | 4.3 | 0.1 | 0.4 | 2.2 | 8.4 | 0.1 | 0.6 | 1.0 | 1.9 | 0.8 | 0.3 | 0.8 |
| 41 | 0.0 | 0.3 | 0.0 | 0.2 | 0.1 | 4.9 | 0.0 | 0.0 | 6.1 | 5.6 | 0.0 | 0.1 | 0.8 | 0.4 | 0.2 | 0.0 | 0.1 |
| 42 | 0.5 | 0.3 | 1.5 | 0.2 | 1.7 | 0.0 | 1.7 | 1.0 | 0.4 | 0.2 | 0.7 | 7.8 | 0.4 | 0.1 | 0.1 | 0.6 | 0.5 |
| 43 | 0.3 | 0.5 | 2.0 | 0.3 | 1.7 | 0.1 | 0.4 | 1.7 | 0.9 | 3.4 | 0.4 | 3.9 | 1.1 | 1.2 | 1.6 | 0.8 | 2.9 |
| 44 | 0.3 | 0.4 | 0.1 | 0.5 | 8.5 | 0.1 | 6.0 | 1.4 | 0.7 | 2.1 | 0.2 | 0.5 | 1.4 | 0.1 | 5.8 | 0.6 | 4.4 |
| 45 | 0.1 | 0.6 | 0.1 | 0.6 | 4.3 | 0.3 | 1.3 | 0.6 | 1.4 | 4.2 | 0.1 | 0.3 | 1.6 | 0.2 | 7.7 | 0.2 | 3.1 |
| 46 | 1.9 | 0.6 | 0.4 | 5.5 | 2.5 | 0.1 | 0.8 | 3.4 | 0.7 | 2.5 | 1.3 | 1.1 | 1.4 | 1.6 | 2.1 | 2.6 | 3.0 |
| 47 | 0.3 | 0.1 | 6.7 | 0.1 | 2.2 | 0.0 | 0.5 | 1.5 | 0.2 | 0.2 | 0.7 | 17.2 | 0.2 | 0.2 | 0.3 | 0.7 | 1.2 |
| 48 | 1.3 | 1.7 | 0.1 | 3.0 | 1.2 | 0.1 | 0.3 | 1.0 | 2.6 | 6.3 | 0.3 | 0.3 | 11.4 | 1.0 | 2.4 | 1.3 | 2.2 |
| 49 | 0.0 | 0.2 | 0.0 | 0.1 | 0.1 | 5.3 | 0.0 | 0.1 | 1.8 | 6.7 | 0.0 | 0.1 | 0.2 | 0.2 | 0.6 | 0.0 | 0.2 |
| 50 | 0.0 | 0.4 | 0.1 | 0.3 | 0.9 | 0.8 | 0.2 | 0.2 | 1.9 | 7.0 | 0.0 | 0.1 | 1.0 | 0.2 | 5.0 | 0.1 | 1.0 |

| | Lapsed | | | | | | | | | | | | | | | | |
|---|---|---|---|---|---|---|---|---|---|---|---|---|---|---|---|---|---|
| State | 34 | 35 | 36 | 37 | 38 | 39 | 40 | 41 | 42 | 43 | 44 | 45 | 46 | 47 | 48 | 49 | 50 |
| Lapsed | 2.3 | 0.6 | 0.1 | 0.0 | 1.5 | 0.2 | 0.0 | 0.0 | 2.5 | 0.1 | 0.1 | 0.1 | 0.2 | 1.3 | 0.4 | 0.0 | 0.0 |
| 1 | 0.0 | 0.0 | 0.1 | 0.0 | 0.0 | 0.3 | 1.1 | 0.8 | 0.0 | 0.3 | 0.0 | 0.0 | 0.1 | 0.1 | 0.1 | 0.6 | 0.0 |
| 2 | 1.3 | 8.2 | 0.3 | 0.1 | 2.0 | 1.2 | 0.4 | 0.2 | 0.4 | 1.4 | 1.3 | 1.0 | 2.3 | 2.3 | 7.5 | 0.2 | 0.3 |
| 3 | 0.0 | 0.1 | 0.2 | 0.5 | 0.1 | 1.1 | 0.5 | 1.0 | 0.0 | 0.2 | 0.0 | 0.0 | 0.1 | 0.1 | 0.2 | 0.5 | 0.1 |
| 4 | 0.0 | 0.1 | 4.3 | 4.8 | 0.1 | 0.6 | 0.1 | 4.4 | 0.0 | 0.1 | 0.0 | 0.1 | 0.3 | 0.1 | 0.3 | 1.1 | 0.2 |
| 5 | 0.0 | 0.1 | 1.5 | 0.2 | 0.0 | 5.3 | 1.1 | 8.0 | 0.0 | 0.3 | 0.1 | 0.2 | 0.1 | 0.1 | 0.5 | 2.7 | 0.4 |
| 6 | 0.8 | 7.6 | 0.6 | 0.4 | 0.4 | 2.1 | 0.1 | 0.1 | 0.1 | 0.2 | 0.2 | 0.2 | 0.7 | 0.3 | 4.4 | 0.0 | 0.1 |
| 7 | 0.1 | 0.4 | 2.7 | 2.6 | 0.1 | 5.5 | 1.2 | 2.9 | 0.1 | 0.4 | 0.1 | 0.2 | 3.6 | 0.2 | 1.3 | 1.4 | 0.4 |
| 8 | 3.2 | 0.7 | 0.1 | 0.0 | 3.7 | 0.2 | 0.1 | 0.1 | 5.2 | 0.2 | 1.1 | 0.3 | 0.5 | 2.1 | 0.4 | 0.1 | 0.1 |
| 9 | 1.4 | 1.2 | 0.2 | 0.1 | 2.7 | 0.8 | 0.2 | 0.3 | 1.4 | 1.0 | 3.9 | 4.1 | 1.1 | 6.9 | 1.7 | 1.3 | 3.0 |
| 10 | 1.4 | 0.7 | 0.0 | 0.0 | 3.8 | 0.3 | 0.7 | 0.1 | 1.5 | 5.3 | 0.1 | 0.1 | 0.9 | 23.2 | 0.8 | 0.1 | 0.1 |
| 11 | 0.1 | 0.3 | 1.3 | 0.1 | 0.1 | 5.1 | 1.5 | 2.7 | 0.1 | 1.1 | 2.2 | 5.5 | 1.2 | 0.4 | 3.4 | 8.5 | 9.2 |
| 12 | 3.9 | 6.6 | 0.2 | 0.2 | 0.8 | 0.5 | 0.1 | 0.0 | 0.1 | 0.1 | 0.1 | 0.1 | 0.7 | 0.4 | 1.8 | 0.0 | 0.0 |
| 13 | 0.8 | 1.4 | 0.4 | 0.1 | 1.6 | 1.3 | 0.2 | 0.7 | 0.7 | 0.3 | 10.5 | 10.6 | 1.1 | 0.6 | 2.2 | 2.3 | 4.6 |
| 14 | 13.5 | 4.9 | 0.1 | 0.3 | 4.3 | 0.3 | 0.1 | 0.1 | 1.0 | 0.2 | 0.2 | 0.1 | 1.6 | 0.9 | 1.2 | 0.0 | 0.0 |
| 15 | 0.2 | 3.1 | 0.7 | 0.1 | 0.6 | 3.1 | 0.9 | 0.5 | 0.2 | 2.1 | 2.1 | 3.3 | 1.9 | 1.3 | 9.1 | 0.9 | 2.2 |
| 16 | 2.6 | 2.4 | 0.5 | 12.3 | 0.4 | 0.1 | 0.0 | 0.0 | 0.1 | 0.1 | 0.1 | 0.1 | 3.4 | 0.2 | 0.7 | 0.0 | 0.0 |
| 17 | 4.7 | 12.7 | 0.2 | 0.2 | 1.9 | 0.6 | 0.1 | 0.0 | 0.3 | 0.2 | 0.2 | 0.1 | 1.7 | 0.8 | 3.5 | 0.0 | 0.0 |
| 18 | 0.1 | 1.3 | 1.2 | 1.2 | 0.1 | 4.5 | 0.2 | 0.3 | 0.0 | 0.2 | 0.1 | 0.2 | 0.3 | 0.2 | 1.9 | 0.1 | 0.1 |
| 19 | 2.5 | 0.3 | 0.0 | 0.0 | 4.6 | 0.1 | 0.1 | 0.0 | 3.6 | 0.8 | 0.1 | 0.1 | 0.3 | 16.3 | 0.3 | 0.0 | 0.0 |
| 20 | 0.3 | 4.5 | 4.2 | 5.1 | 0.3 | 5.5 | 0.2 | 0.3 | 0.1 | 0.2 | 0.2 | 0.3 | 4.6 | 0.2 | 6.3 | 0.1 | 0.2 |
| 21 | 2.1 | 2.1 | 0.1 | 0.1 | 3.6 | 0.4 | 0.1 | 0.1 | 1.6 | 0.6 | 4.7 | 2.4 | 1.5 | 3.0 | 2.0 | 0.1 | 0.5 |
| 22 | 0.0 | 0.0 | 0.2 | 0.0 | 0.0 | 0.6 | 3.5 | 6.8 | 0.0 | 0.3 | 0.1 | 0.3 | 0.1 | 0.1 | 0.1 | 7.8 | 0.6 |
| 23 | 1.8 | 1.3 | 0.1 | 0.0 | 3.2 | 0.2 | 0.1 | 0.1 | 2.7 | 0.3 | 5.7 | 1.4 | 0.9 | 1.5 | 0.9 | 0.1 | 0.2 |
| 24 | 3.8 | 3.5 | 0.1 | 0.0 | 5.5 | 0.3 | 0.2 | 0.1 | 1.5 | 0.8 | 1.2 | 0.6 | 2.7 | 3.6 | 2.1 | 0.1 | 0.1 |
| 25 | 0.0 | 0.5 | 3.0 | 0.9 | 0.1 | 9.3 | 0.4 | 2.3 | 0.0 | 0.3 | 0.1 | 0.2 | 0.1 | 0.1 | 1.4 | 0.7 | 0.3 |
| 26 | 0.1 | 0.9 | 3.3 | 0.2 | 0.2 | 10.6 | 2.6 | 4.2 | 0.1 | 1.6 | 0.9 | 2.0 | 1.2 | 0.5 | 6.8 | 5.3 | 3.3 |
| 27 | 8.4 | 4.2 | 0.1 | 0.1 | 6.9 | 0.3 | 0.1 | 0.1 | 1.9 | 0.4 | 0.4 | 0.2 | 2.4 | 3.0 | 1.4 | 0.0 | 0.0 |
| 28 | 3.0 | 0.3 | 0.0 | 0.0 | 4.4 | 0.1 | 0.1 | 0.0 | 4.3 | 0.4 | 0.1 | 0.1 | 0.3 | 10.2 | 0.2 | 0.0 | 0.0 |
| 29 | 0.1 | 5.1 | 3.3 | 0.3 | 0.2 | 10.1 | 0.3 | 0.5 | 0.1 | 0.3 | 0.3 | 0.5 | 0.4 | 0.3 | 8.8 | 0.2 | 0.3 |
| 30 | 0.7 | 3.6 | 1.8 | 0.3 | 0.7 | 4.3 | 2.1 | 1.1 | 0.2 | 2.4 | 0.2 | 0.3 | 3.2 | 1.8 | 5.0 | 0.6 | 0.3 |
| 31 | 0.2 | 1.5 | 0.5 | 0.1 | 0.4 | 2.1 | 0.4 | 0.4 | 0.2 | 1.1 | 5.6 | 7.6 | 1.9 | 0.7 | 5.1 | 1.0 | 4.5 |
| 32 | 4.8 | 8.7 | 0.2 | 0.1 | 4.0 | 0.5 | 0.1 | 0.1 | 0.8 | 0.5 | 0.5 | 0.3 | 2.5 | 2.1 | 3.5 | 0.0 | 0.1 |
| 33 | 0.9 | 3.3 | 0.2 | 0.1 | 2.1 | 0.7 | 0.3 | 0.1 | 0.6 | 1.2 | 3.3 | 2.5 | 2.2 | 2.8 | 4.0 | 0.2 | 0.7 |
| 34 | 17.6 | 1.8 | 0.1 | 0.1 | 6.2 | 0.3 | 0.1 | 0.1 | 3.3 | 0.2 | 0.2 | 0.1 | 1.0 | 2.7 | 0.6 | 0.1 | 0.0 |
| 35 | 1.1 | 15.4 | 0.6 | 0.2 | 1.0 | 1.9 | 0.2 | 0.1 | 0.2 | 0.5 | 0.5 | 0.4 | 1.7 | 0.8 | 10.2 | 0.1 | 0.1 |
| 36 | 0.1 | 0.8 | 24.7 | 2.6 | 0.1 | 7.4 | 0.2 | 5.8 | 0.1 | 0.1 | 0.2 | 0.4 | 0.7 | 0.1 | 4.0 | 1.4 | 0.7 |
| 37 | 0.1 | 0.4 | 4.1 | 48.0 | 0.1 | 0.6 | 0.0 | 0.4 | 0.1 | 0.0 | 0.1 | 0.1 | 1.1 | 0.1 | 0.4 | 0.1 | 0.1 |
| 38 | 7.1 | 1.4 | 0.1 | 0.1 | 7.2 | 0.3 | 0.1 | 0.1 | 3.5 | 0.5 | 0.4 | 0.2 | 1.2 | 6.8 | 0.8 | 0.1 | 0.1 |
| 39 | 0.0 | 1.1 | 3.0 | 0.2 | 0.1 | 23.3 | 0.8 | 4.7 | 0.0 | 0.5 | 0.3 | 0.6 | 0.4 | 0.2 | 5.4 | 1.7 | 1.0 |
| 40 | 0.1 | 0.6 | 0.3 | 0.0 | 0.4 | 3.0 | 20.3 | 4.0 | 0.1 | 9.2 | 0.1 | 0.5 | 1.4 | 2.5 | 2.2 | 8.7 | 0.9 |
| 41 | 0.0 | 0.1 | 4.1 | 0.2 | 0.0 | 8.4 | 2.1 | 20.9 | 0.0 | 0.4 | 0.2 | 0.7 | 0.2 | 0.1 | 0.9 | 10.4 | 1.7 |
| 42 | 3.9 | 0.5 | 0.2 | 0.1 | 3.3 | 0.2 | 0.1 | 0.1 | 20.2 | 0.2 | 0.2 | 0.1 | 0.4 | 3.1 | 0.4 | 0.1 | 0.0 |
| 43 | 0.7 | 1.2 | 0.1 | 0.0 | 1.9 | 1.1 | 4.1 | 0.4 | 0.6 | 13.7 | 0.3 | 0.5 | 1.8 | 12.2 | 2.5 | 0.6 | 0.4 |
| 44 | 0.3 | 1.3 | 0.5 | 0.2 | 0.6 | 1.2 | 0.1 | 0.5 | 0.4 | 0.2 | 20.9 | 11.4 | 1.1 | 0.4 | 2.3 | 1.4 | 4.6 |
| 45 | 0.1 | 0.7 | 0.8 | 0.2 | 0.3 | 2.2 | 0.3 | 1.3 | 0.2 | 0.4 | 11.5 | 13.9 | 1.3 | 0.3 | 2.8 | 4.5 | 9.5 |
| 46 | 1.6 | 3.4 | 0.8 | 0.7 | 1.9 | 1.1 | 0.8 | 0.3 | 0.6 | 1.3 | 1.0 | 1.2 | 23.0 | 1.6 | 3.7 | 0.6 | 0.8 |
| 47 | 2.2 | 0.5 | 0.0 | 0.0 | 4.8 | 0.1 | 0.2 | 0.0 | 2.6 | 1.6 | 0.1 | 0.1 | 0.5 | 21.3 | 0.4 | 0.1 | 0.1 |
| 48 | 0.2 | 7.6 | 2.1 | 0.1 | 0.4 | 6.9 | 0.6 | 0.6 | 0.1 | 0.9 | 0.8 | 1.1 | 1.5 | 0.6 | 16.8 | 0.3 | 0.7 |
| 49 | 0.0 | 0.0 | 0.9 | 0.0 | 0.1 | 2.7 | 4.1 | 9.8 | 0.0 | 0.6 | 1.0 | 3.1 | 0.4 | 0.2 | 0.4 | 33.3 | 8.4 |
| 50 | 0.0 | 0.2 | 1.0 | 0.1 | 0.1 | 3.1 | 0.6 | 2.9 | 0.1 | 0.4 | 5.3 | 10.8 | 0.9 | 0.2 | 1.6 | 13.1 | 16.7 |

1. A computer implemented method for inferring creditworthiness of a mobile phone user, the method comprising:
receiving, by a computer, call level data for each of a first plurality of mobile phone users, with the call level data being for a period of common duration;
deriving, by the computer, attributes from the received call level data;
defining, by the computer, an attribute space based on the derived attributes with each mobile phone user being represented by an attribute vector;
partitioning, by the computer, the attribute space into clusters of attribute vectors;
receiving, by the computer, a measure of creditworthiness for each of a second plurality of mobile phone users with the second plurality of mobile phone users being a subset of the first plurality of mobile phone users;
mapping, by the computer, each received measure of creditworthiness to at least one cluster corresponding to the mobile phone user from the subset;
characterizing, by the computer, the creditworthiness of each cluster as a function of the creditworthiness mapped thereto; and
inferring, by the computer, the creditworthiness of a given mobile phone user in a given cluster as a function of the creditworthiness characterizing the given cluster.
